(19) United States
(12) Patent Application Publication
(10) Pub. No.: US 2005/0204405 A1
(43) Pub. Date: Sep. 15, 2005

(54) Method and system for digital rights management

(76) Inventors: Brian Wormington, Otis, MA (US); William R. Lear JR., Fairport, NY (US)

Correspondence Address: JAECKLE FLEISCHMANN & MUGEL, LLP, 190 Linden Oaks, ROCHESTER, NY, 14625-2812, US

(21) Appl. No.: 11/071,924

(22) Filed: Mar. 4, 2005

Related U.S. Application Data
(60) Provisional application No. 60/549,994, filed on Mar. 4, 2004.

(51) Int. Cl. H04L 9/32

(52) U.S. Cl. 726/27; 713/189

(57) ABSTRACT

In a method and system for digital content management, in order for an end-user application on a consumer electronic device to be fully functional, the end-user must have a secure computing device, such as a smart card or dongle, in communication with the consumer electronic device. The secure computing device contains critical code fragments necessary for the complete execution of the end-user application and can hold the critical code fragments of multiple applications from multiple vendors. Applications can be updated by vendors when the secure computing device is in communication with a WAN. In a network environment, consumers can execute code from a secure computing device in communication with a local area network or a master secure computing device can transfer licenses to multiple secure computing devices in communication with the master secure computing device via a local area network server.

### CROSS-REFERENCE TO RELATED APPLICATIONS

This application claims the benefit of U.S. Provisional Application No. 60/549,994 filed Mar. 4, 2004, the entire disclosure of which is incorporated by reference in its entirety for any and all purposes.

### BACKGROUND

Unauthorized copying and use of intellectual property has been a problem since the first recording and duplication methods were invented. Printed documents, photographs, audio and video recordings have all been targets for unlicensed usage. Prior to the existence of digital technologies, it was difficult to create duplicates of protected information that could not be differentiated from the original. Often, the cost to create and distribute copies of acceptable quality approached the cost of acquiring an authorized version.

The cost and difficulty of creating and disseminating high quality copies have been greatly reduced due to three recent technology trends: 1) the rapid emergence of the personal computing environment; 2) digital representations of most forms of intellectual property such as books, music, photographs, video and computer software; 3) growth of the internet and peer-to-peer file sharing technologies.

Using technologies available on many personal computers, exact digital copies can be made of digital content representations. The development of the internet and particularly of peer-to-peer networking has enabled the rapid dissemination of thousands of these unauthorized copies to anyone with a network connection or modem.

Software creators and distributors recognize that this illegal copying and dissemination results in significant lost revenues. Various methods have been invented to address this problem. They have ranged from software serial numbers and activation codes to cryptographic hardware protection devices (“dongles”), to network based client-server license management systems, to smart card based protection techniques.

Unfortunately, many of the prior software protection mechanisms have achieved their effectiveness at the expense of inconvenience or additional usage restrictions for legitimate users or have been ineffective because end-users circumvent the copy protection.

U.S. Pat. No. 5,337,357 to Chou et al describes a protected software distribution in which a content provider encrypts the software using a key based on a profile or fingerprint of the configuration of the target computer. This method has the significant disadvantage of tying the execution of a software application to a specific computer. To move the protected application to another computer or to replace the computer running the application, a new fingerprint must be generated, and a new encrypted software distribution delivered.

U.S. Patent Application Publication No. 2002/014416 by Giobbi describes a digital rights management solution in which the recipient uses a physical electronic key to decrypt encrypted digital information such as software received from a content provider. Other than the method for determining the encryption key, the distribution process is similar to that described in U.S. Pat. No. 6,266,416. The Giobbi approach uses a simple fixed electronic key rather than a smart card. This means that either the solution works with only a single content provider, or different content providers must encrypt using the same key, or the end-user must have multiple key devices.

U.S. Pat. No. 6,266,416 to Sigbjornsen et al, and the subsequent continuation application Ser. Nos. 09/873,351 and 10/752,429 show one technique for using an external secure computing unit such as a smart card to protect against software usage without permission. Sigbjornsen describes two useful concepts: 1) Encrypting a portion of the software application distribution in such a way that it can be decrypted and executed only on a computer in communication with the smart card. 2) Decrypting and executing the encrypted portion of the of the software application in the smart card rather than on the primary computer. Sigbjornsen's approach also has limitations: 1) The smart cards are expected to be programmed and distributed by the software application vendor. This means that a separate smart card is required for each application vendor. 2) There is no described method for updating smart card contents after initial acquisition. 3) The scope of the Sigbjornsen patent is also limited to the actual software protection operation. It does not address the issues of secure and flexible distribution, software version upgrade, or multiple vendor support.

U.S. Pat. No. 5,754,646 to Williams et al (1998) describes a similar software protection mechanism of encrypting part of the protected software application, and then decrypting and running that part on an external secure hardware device such as a smart card. In the Williams patent, the encrypted software resides in volatile memory within the smart card, and must be downloaded from a network prior to each use. This approach has at least two limitations: 1) The user's computer must be connected to the network each time a protected application is started. 2) The approach again does not support simultaneous protection of multiple applications or multiple vendors.

Accordingly, there is a need in the art for a method and system of digital rights management that will prevent the illegal copying and dissemination of end-user applications and preferably has at least one of the following qualities: allows for flexible software distribution, software version upgrade and multiple vendor support; no need for a network connection each time a protected application is started; and the ability to be used easily in a license pool.

### SUMMARY

This need is fulfilled by a method of digital rights management comprising: allowing an end-user to execute a first portion of code on a consumer electronic device; allowing the end-user to install a second portion of code on a secure computing device, in communication with the consumer electronic device, wherein the second portion of code is encrypted; allowing the end-user to download a first decryption key for the second portion of code; allowing the end-user to decrypt the second portion of code; allowing the end-user to execute the second portion of code in the secure computing device; and allowing the end-user to register the end-user application.

The second portion of code can be copied or transferred from the consumer electronic device to the secure computing device and the first decryption key can be downloaded to the secure computing device from a an end-user application vendor. Alternatively, the second portion of code can be downloaded to the secure computing device from the end-user application vendor.

Preferably, the end-user application can only be fully functional when the second portion of code is executed and the end-user must register the end-user application before the end-user is allowed to execute the second portion of the code.

The first portion of code preferably contains at least one call to the second portion of code and the second portion of code comprises at least one critical code fragment.

The method of digital rights management can further comprise: allowing an end-user to install a third portion of code on the secure computing device, wherein the third portion of code is encrypted; and allowing an end-user to download a second decryption key for the third portion of code.

The third portion of code and/or the decryption key can be downloaded from a second end-user application vendor to the secure computing device.

In another embodiment, a method of digital rights management comprises: installing a first portion of code on a consumer electronic device; installing a second portion of code on a secure computing device in communication with the consumer electronic device wherein the second portion of code is encrypted; downloading a first decryption key for the second portion of code; decrypting the second portion of the code; and executing the second portion of code in the secure computing device.

In yet another embodiment, a method of digital rights management comprises: allowing an end-user to execute a first portion of code of a first end-user application on a consumer electronic device; allowing the end-user to execute a second portion of code of the first end-user application on a secure computing device in communication with the consumer electronic device, wherein the end-user able to execute a portion of code of a second end-user application on the secure computing device.

The first end-user application can be licensed or purchased from a first vendor and the second end-user application can be licensed or purchased from a second vendor.

In a further embodiment, a method of digital rights management comprises: allowing a first end-user to execute a first portion of code of the end-user application on a first consumer electronic device; allowing a second end-user to execute the first portion of code of the end-user application on a second consumer electronic device; and allowing the first and second end-users to execute a second portion of code of the end-user application on a secure computing device in communication with a local area network server; wherein the local area network server is in communication with both the first and second consumer electronic devices.

Optionally, a digital identification device is in communication with the first consumer electronic device.

In an additional embodiment, a system of digital rights management comprises: a local area network server; a master secure computing device in communication with the local area network server, the master secure computing device having n transfer tokens; at least one consumer electronic device in communication with the local area network server; an end-user secure computing device in communication with one of the at least one consumer electronic device; wherein a first portion of code of the end-user application can be executed on the at least one consumer electronic device and, after one of the n transfer tokens is transferred to the end-user secure computing device, a second portion of code of the end-user application can be executed on the end-user secure computing device.

Finally, a system of digital rights management can comprise: a local area network server; a secure computing device in communication with the local area network server; and at least one consumer electronic device in communication with the local area network server; wherein a first portion of code of the end-user application can be executed on the at least on consumer electronic device and a second portion of code of the end-user application can be executed on the secure computing device.

### BRIEF DESCRIPTION OF THE DRAWINGS

These and other features, aspects and advantages of the present invention will become better understood with regard to the following description, appended claims, and accompanying drawings where:

FIG. 1 shows the high level layered architecture of a digital rights management system that can be used in conjunction with embodiments of the present invention;

FIG. 2 is a block diagram representing major components of the digital rights management system of FIG. 1;

FIG. 3 is a diagram showing the main software elements of the digital rights management system of FIG. 1, which reside on the consumer electronic device;

FIG. 4 is a diagram showing the main software and data elements of the digital rights management system of FIG. 1, which reside on the digital rights management server;

FIG. 5 is a diagram showing the main software and data elements of the digital rights management system of FIG. 1, which reside on the digital content vendor server;

FIG. 6 is a block diagram representing primary functional elements in the portable secure computing device of the digital rights management system of FIG. 1;

FIG. 7 is a diagram showing the main software elements of the digital rights management system of FIG. 1, which reside on the secure computing device of FIG. 6;

FIGS. 8a-8c are block diagrams showing potential options for connecting the portable secure computing device of FIG. 6 to a consumer electronic device; and

FIG. 9 is a block diagram showing an alternate centralized Local Area Network connected secure computing device configuration option.

### DESCRIPTION

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

The present application relates to the secure and flexible distribution and sale of digital content, in particular end-user applications, including software, games, music, movies and all forms of digital media; the management and enforcement of usage license rights assigned by the digital content rights holder; and the protection of the digital content against unauthorized use.

This application concerns in particular a novel method and system for distribution and sale of digital content; methods and systems allowing a digital content vendor to remotely store and manage digital content usage rights information in a portable secure computing hardware device in the possession of an authorized user; a method and system for validating those usage rights and enabling authorized usage of the digital content on a computer or other digital device; and a method and system for protecting against the unauthorized use of protected digital content by a user not in possession of a properly enabled secure computing device.

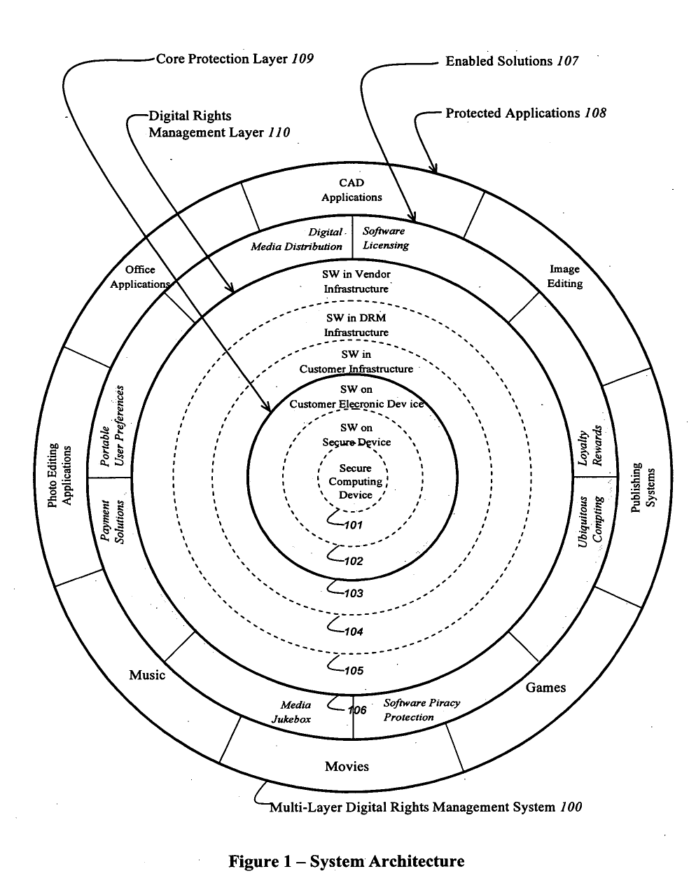

A preferred secured manner of distributing end-user applications is illustrated in FIG. 1 and includes a comprehensive multi-layer system for digital rights management (“DRM”) including but not limited to end-user distribution, licensing and copy protection. It insures that only users with proper authorization are able to access and use the protected content. The DRM system enables additional usage rights and flexibilities not available with other DRM systems. Furthermore, the DRM system includes a novel associated distribution system that makes it possible for legitimate users to distribute digital content to secondary users on a trial basis and facilitates the compensation of the original users upon conversion of these secondary users into fully licensed users through a secure registration system. In this way large volumes of digital content can be transferred from user to user without any compromise of authorized usage permissions. Thus, media vending companies can leverage their existing user base to find and recruit additional customers at very low cost.

Although this preferred secure manner of distributing end-user applications is disclosed other methods known in the art can be used.

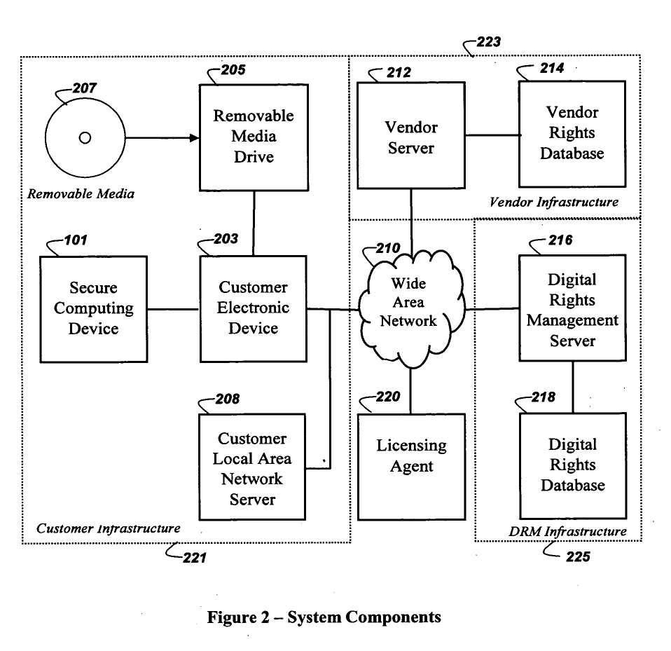

At the center of the comprehensive multi-layer system 100 for DRM shown in FIG. 1 is the secure computing device (“SCD”) 101. System components are shown in FIG. 2. The SCD 101, software 102 on the SCD and software 103 on a consumer electronic device 203 form a core protection layer 109 of the system 100. The consumer electronic device 203 can be of any type including a computer, cell phone, PDA, gaming device, TV, etc. Software 104 in customer infrastructure 221, software 105 in DRM infrastructure 205 and software 106 in vendor infrastructure 223 form a DRM layer 110. The system 100 has several enabled solutions 107 such as digital media distribution. The digital media includes protected application 108 including music, movies, games, office applications, etc.

Some system components shown in FIG. 2 include the SCD 101, end-user electronic device 203, removable media drive 205, removable media 207, wide area network 210, vendor server 212, vendor rights database 214, DRM server 216, digital rights database 218 and a licensing agent 220. The SCD 101, end-user electronic device 203, removable media drive 205, removable media 207 and customer local area network server 208 are all parts of the customer infrastructure 221. The vendor server 212 and vendor rights database 214 are parts of the vendor infrastructure 223. Finally, the DRM server 216 and the digital rights database 218 are parts of the DRM infrastructure 225. All of these examples of system components are not necessary in embodiments of the invention but are merely an example of components that could be used to implement an embodiment of the invention.

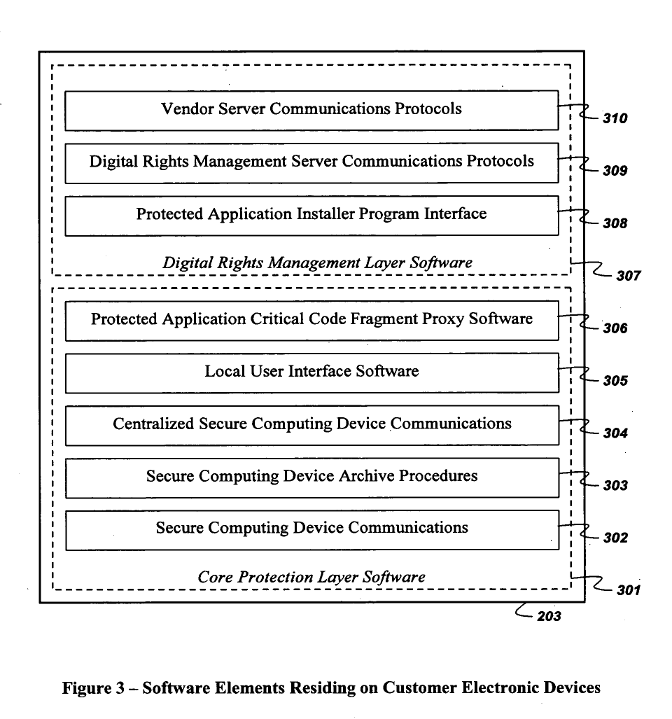

FIG. 3 shows software elements that may reside on a consumer electronic device 207. The elements include core protection layer software 301 and DRM layer software 307. The core protection layer software can include SCD communications software 302, SCD archive procedures software 303, centralized SCD communications software 304, local user interface software 305 and protected application critical code fragment (“CCF”) proxy software 306. The DRM layer software 307 can include protect application installer program interface software 308, DRM server communications protocols software 309 and vendor server communications protocols software 310.

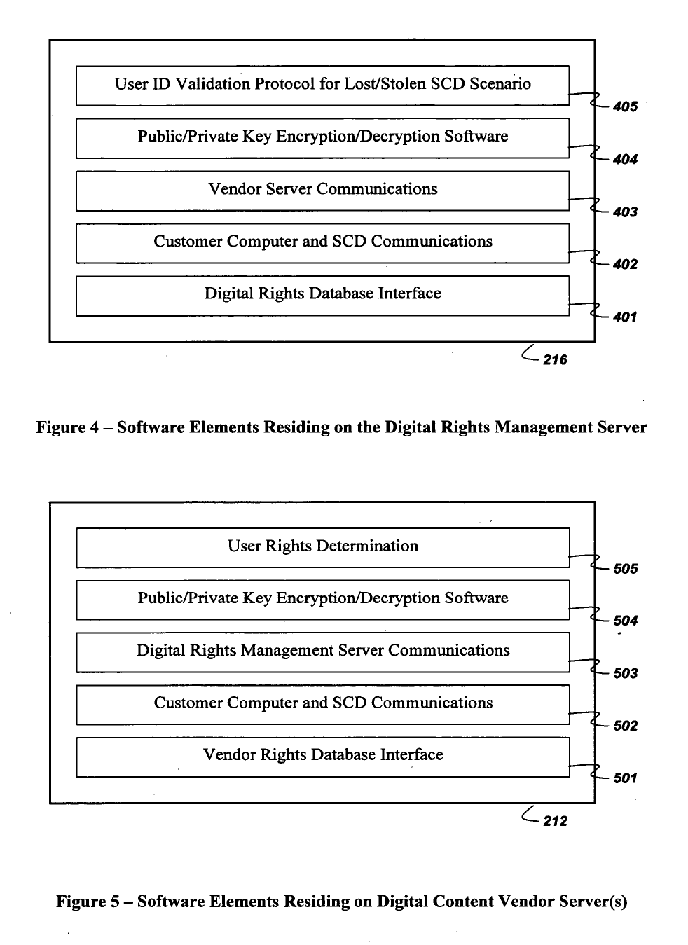

FIG. 4 shows software elements that may reside on the DRM server 216. These elements include digital rights database interface software 401, consumer electronic device and SCD communications software 402, vendor server communications software 403, public/private key encryption/decryption software 404 and user ID validation protocol for lost/stolen SCD scenario software 405.

Similarly, the software elements shown in FIG. 5 that may reside on the digital content vendor server 212 include vendor rights database interface software 501, consumer electronic device and SCD communications software 502, DRM server communications software 503, public/private key encryption/decryption software 504 and user rights determination software 505.

Secure Computing Device

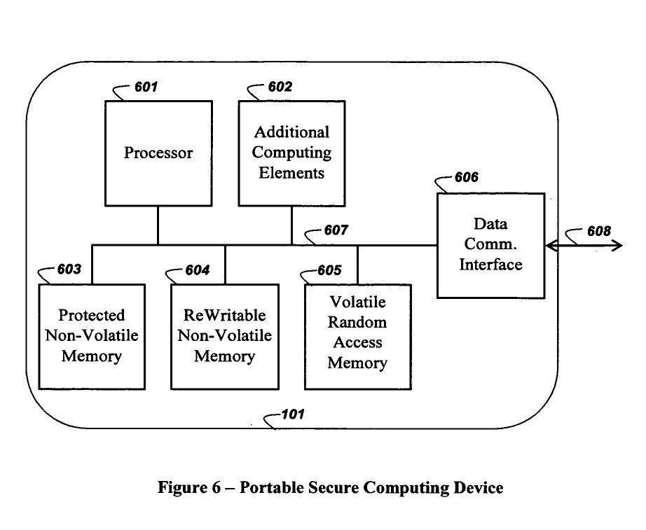

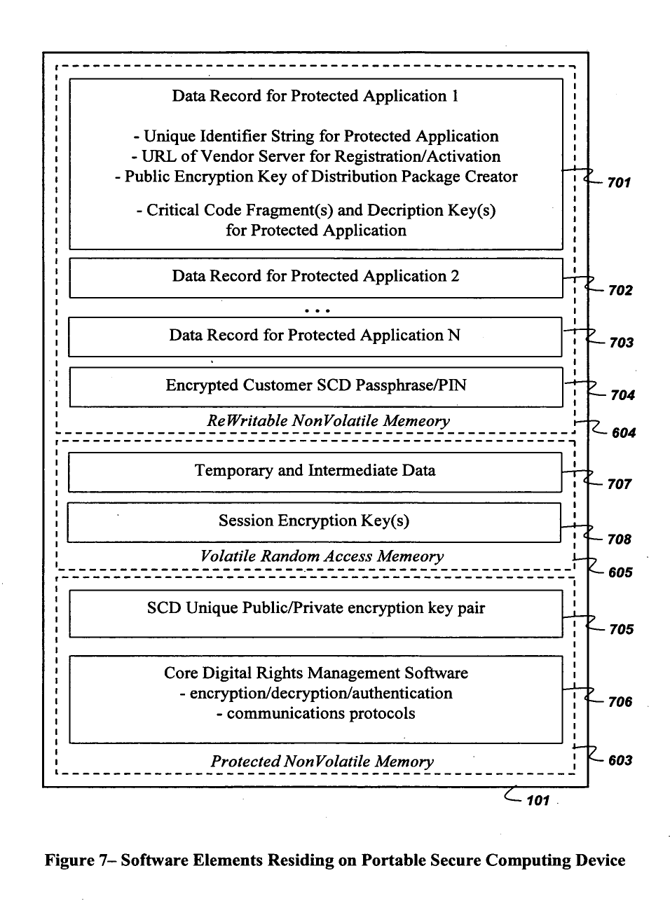

FIG. 6 shows the primary functional elements and FIG. 7 shows the software elements in the SCD 101. The SCD 101 preferably contains:
Protected Non-Volatile Memory (PNVM) 603 for storing the program instructions of the SCD resident core DRM software 706, and for storing a Public/Private Encryption key pair 705 unique to each particular SCD 101. The contents of the PNVM 603 are written prior to delivery to a customer, and cannot be read or altered by any customer initiated actions.
Re-writable Non-Volatile Memory (RWNVM) 604 for storing the data records 701, 702, 703 for each protected end-user application registered to the particular SCD 101. The RWNVM 604 also stores an encrypted customer SCD pass phrase or Pin 704. The contents of the RWNVM 604 are altered during the various usage scenarios, but cannot be directly read or altered by the customer.
Volatile Random Access Memory (RAM) 605 for storing intermediate results and temporary data 707 and session encryption key(s) 708 required for proper operation of the software program instructions contained in the PNVM 603 and RWNVM 604. The contents of the RAM cannot be directly read or altered by the customer. The contents of the RAM are lost when power is disconnected from the SCD 101.
One or more general purpose processing elements 601 for executing software program instructions contained in the PNVM 603 and RWNVM 604.
Zero or more Optional additional computing elements 602 for optimized execution of real-time clock and timer functions, computationally complex encryption, decryption, and authentication algorithms.
One or more Data Communications Interfaces 606 and external interconnections 608 providing a method for reliably providing power to the SCD 101 and for transferring digital data between the SCD and the consumer electronic device 203.
One or more internal data communications paths 607 providing a method for reliably transferring digital data between the modules within the SCD 101. The data on these paths cannot be directly viewed or altered by the customer.
Tamper-resistant packaging 309 which prevents anyone from gaining useable information regarding the data and software contained in the SCD 101. This includes, but is not limited to protection against physical or electrical access to the internal SCD elements without destroying the data and software contained therein.

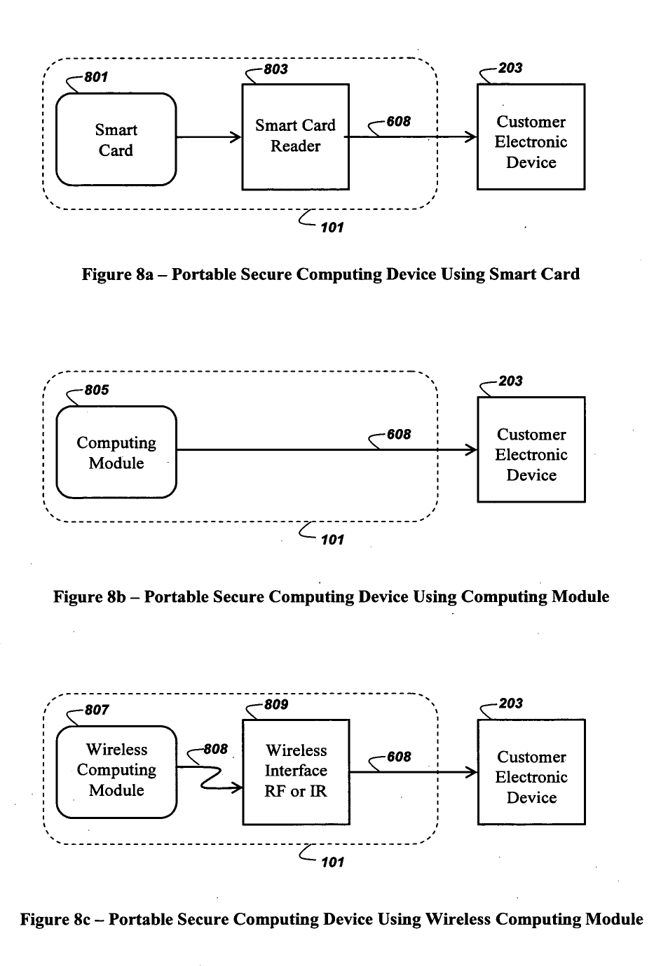

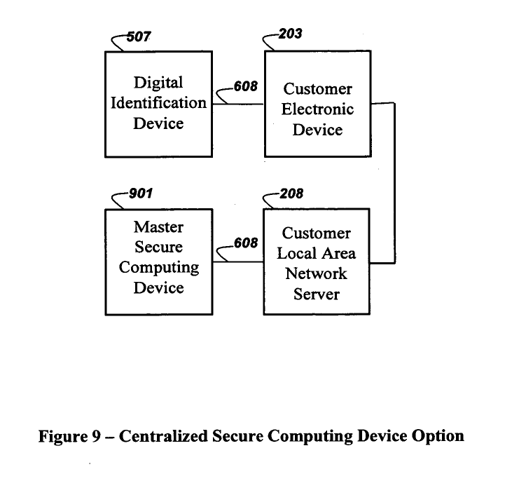

FIGS. 8a-8c show three possible alternative configurations for connecting the SCD 101 to the consumer electronic device 203.
FIG. 8a shows a conventional smart card 801 which is physically mated with a smart card reader 803. The reader 803 is in communication with the consumer electronic device 203 via an external connection 608 supported by the particular device. Example interfaces include but are not limited to PCMCIA card slot, RS232 Serial port, Universal Serial Bus (USB) connection, FireWire Connection, PCI bus connection, and Network interface. The reader 803 could be external to or built into the consumer electronic device 203.
FIG. 8b shows a similar configuration in which the reader 803 is eliminated because a computing module 805 directly connects to a communications interface 406 supported by the consumer electronic device 203. Example interfaces include but are not limited to PCMCIA card slot, RS232 Serial port, USB, FireWire and Network interface. The secure computing module 805 would typically be external to and removable from the consumer electronic device 203. The secure computing module 805 can be built into the device 203, but digital rights assigned to that SCD 101b are then inherently linked to that specific consumer electronic device.
FIG. 8c shows a configuration in which the wireless computing module 807 communicates with the consumer electronic device 203 via a wireless transmission 808 to a wireless interface 809 connected to the consumer electronic device via a supported communications interface 608. The wireless transmission 808 could use radio frequency (RF), InfraRed (IR), or other wireless methods. The wireless interface 809 could be external to or built in to the consumer electronic device 203.
FIG. 9 shows an alternative system configuration in which the customer Local Area Network server 208 is in communication with a master SCD 901. This configuration offers some advantages in certain multiple consumer electronic device/multiple license environments. This configuration is particularly suited to License Pool Operation.

In this option, a master SCD 901 is in communication with a customer LAN server 208 which is in turn in communication with one or more consumer electronic devices 203. The master SCD 901 can use any of the alternative configurations shown in FIGS. 8a, 8b and 8c to connect to the customer LAN server 208. In this case, customer identification is separated from digital rights authorization.

Individual customers identify themselves at a particular consumer electronic device 203 by connecting a digital identification device (DID) 907 to the consumer electronic device. The DID 907 may be an RF ID tag or dongle, or could be another SCD 101. The DID 907 is not used to directly determine software usage rights. Rather, the DID 907 is used to identify the user to the master SCD 901 via software running on the customer LAN server 208.

Preparation of End-User Application for Protection

A vendor must specially prepare an end-user application to enable the protection, distribution, and rights management features offered by the present DRM system. This preparation includes:
1. Identify one or more CCFs within the application software source code. A CCF is a small section of code that preferably meets the following criteria:
   a. Required for proper operation of the end-user application
   b. Relatively small and self-contained with minimal internal state—although CCFs can rely on state variable values modified during the execution of other CCFs.
   c. Algorithmically non-trivial—infeasible to discern algorithm from examining only inputs and outputs
   d. No direct dependency during execution on resources available only while running on the consumer electronic device 203—such as disk drives, graphics systems, special hardware.
2. Replace all occurrences of the CCFs in the application software with calls to proxy software 306 in the core protection layer software 301 on the consumer electronic device 203. This proxy software 306 collects the arguments required by the CCF, passes these arguments to the CCF running on the SCD 101, and returns any results generated by the CCF. The proxy software 306 is responsible for encrypting and decrypting data supplied to and received from the SCD 101.
3. Convert the application software to object code for the target consumer electronic device type. Optionally apply additional obfuscation techniques to the application during or after this conversion to discourage attempts to disassemble or modify the application code.
4. Create a distribution and installation package for the application software, including an installer program compatible with Scenario B, infra. A distribution and installation package comprises the files and information necessary to install and use an end-user application on the consumer electronic device 203 minus the CCFs, which are replaced with calls to proxy software, as discussed. Alternatively, the distribution and installation package can include the CCFs in encrypted form. The distribution and installation package may comprise one or more packages that can be transferred together or separately.
5. Convert the CCFs to object code for each supported Secure Computing Device type. During this conversion, interject multiple areas within the CCF object code for the later inclusion of random data patterns. These areas will be used in Scenario B, infra, to ensure that no two CCF binary images are ever identical prior to encryption with a user SCD encryption key.
6. Optionally encrypt these CCFs with a key known only to the Vendor—for added security while the CCFs are stored.
7. Store these converted and optionally encrypted CCFs on the Vendor Server 212 for use in Scenario B, infra. Alternatively, include and distribute the converted and encrypted CCFs with the distribution and installation package for the application for use in Scenario B, infra,
8. Securely store and protect the CCF source code and unencrypted object code to prevent theft or unintentional loss.
   Software Usage Rights Enforcement

In order to run a protected application, a user must have access to a consumer electronic device 203 on which the protected application is (or can be) installed, and must possess an SCD 101 which can be connected to the consumer electronic device, and must know the pass phrase or Personal Identifier Number for the specific SCD. Furthermore, the SCD 101 must have been programmed, via Scenario B, infra to contain a valid data record authorizing the desired usage for the protected application software.

Of these requirements, only the SCD 101 and PIN/Pass phrase are unique items. Any number of consumer electronic devices 203 may contain the installed protected application, and any customer in possession of the enabled SCD 101 and the associated PIN/Pass phrase may use them to run the protected application.

Thus, software usage rights are linked to an SCD 101, not to a particular consumer electronic device 203. The customer is free to run the application on any one of multiple consumer electronic devices 203, and can upgrade or replace any consumer electronic device without requiring involvement of the digital rights owner/software vendor.

There is no restriction on the number of customers that can obtain SCDs, nor on the number of SCDs a customer may obtain. On the contrary, the advantages of the present invention increase as more customers obtain SCDs.

Each SCD 101 can contain authorization data records for multiple end-user applications from multiple vendors. The number of end-user applications which can be concurrently authorized by one SCD 101 is limited only by the memory capacity and possibly computational power of the SCD. Thus, the present DRM system is scalable as new technologies become available for use in the SCD 101. As memory capacities increase, more protected applications may be enabled by a single SCD 101. Faster computational elements enable more complex CCFs, and allow the customer to simultaneously run an increased number of protected applications.

License Pool Operation

Company environments can sometimes benefit from an alternate software usage rights management model. Often, multiple users in a company require access to the same set of end-user applications. Each user could of course be assigned an SCD 101 containing authorization rights for all end-user applications required by that user.

Rarely, however, is it necessary for all users to access the same software simultaneously. A more economical solution would be for the company to acquire some number of usage licenses for each end-user application, but not enough for each user to have a permanent license for all needed applications. Rather, each potential user would borrow a license from this central license pool when they wish to use a protected application, and return the license when finished.

A license pool could, of course, be implemented as an actual collection of SCDs 101, each containing the authorization for a single end-user application. Users could then borrow an SCD 101, learn the associated PIN/Pass phrase, and run the desired application on any consumer electronic device 203 on which the application has been installed. The user would then return the SCD 101 to the pool when finished. This simple approach might work adequately for small organizations, but becomes unmanageable for large groups.

The present DRM provides a method for implementing a centralized digital license pool in which usage authorizations are transferred electronically.

The company or organization acquires the desired number of usage licenses for each needed application, and registers these usage rights on one or more master SCDs 901. A master SCD data record for each application contains a count representing the number of simultaneous copies of the protected application that can be run simultaneously.

The master SCD'(s) 901 are connected to the customer LAN server 208 connected to a number of consumer electronic devices 203 on which the various application packages have been installed.

When a user wishes to use one of the protected applications, he connects his own SCD 101 or DID 907 to one of the consumer electronic devices 203, establishes a LAN connection to the central license pool server, and requests a license for the desired application. If the master SCD 901 contains an unused authorization for the application, the server software provides the master SCD 901 with the public encryption key for the user's SCD 101 or DID 907, and directs the master SCD 901 to create a license transfer token string and decrement the availability count for the requested license.

The server software sends the transfer token to the user's SCD 101 or DID 907, which uses it to create an authorization data record for the application.

When the user is finished with the application, the process is reversed to return the usage authorization to the master SCD 901.

Protection Against Loss or Theft of Secure Computing Device

Since a customer's software usage rights are linked to a specific SCD 101, loss or theft of that SCD could pose a significant hardship on the customer. The present DRM system includes five specific safeguard methods for mitigating these hardships:

First, as described in Usage Scenario F, injra, the customer may configure the SCD 101 to require the entry of a PIN or Pass phrase each time the SCD is connected to a consumer electronic device 203. The SCD 101 is not useable by anyone who does not know the PIN/Pass phrase. The SCD 101 is programmed to deactivate itself if an incorrect PIN/Pass phrase is entered too many times. Once deactivated, the SCD 101 is not useable until the customer reactivates the SCD using the method described in Usage Scenario I, infra. This reactivation procedure requires independent proof of the Customer's identity. This proof includes
Customer access to and response from the email account specified by the customer during the initial registration of the SCD 101;
Proper responses to a sequence of questions answered by the customer during the initial registration of the SCD 101.

Second, the customer can report an SCD 101 lost or stolen and request it to be deactivated by accessing the DRM server 216 via the wide area network 210. Similar to the reactivation procedure, this deactivation procedure requires independent proof of the customer's identity. When the data record for a specific SCD 101 in the digital rights database 218 has been marked for deactivation, the SCD will be directed to deactivate itself the next time it is used in any scenario requiring communications with the digital rights server via the WAN 210.

Third, each SCD 101 is programmed to automatically deactivate itself if a predetermined time period elapses without the customer performing a usage scenario requiring connection to the WAN 210. If, during this time period, the customer does not perform any of the scenarios requiring communications with the DRM Server 216, the customer must explicitly perform the “Phone Home” procedure described in Usage Scenario G, infra. This procedure assures that a lost or stolen SCD 101 will be deactivated in a reasonable timeframe. If an SCD 101 is allowed to deactivate itself due to lack of communications with the DRM Server 216, the legitimate customer can reactivate it by performing the reactivation procedure described in Usage Scenario I, infra.

Fourth, the customer can transfer all rights previously assigned to a deactivated SCD 101 to a new SCD by using the procedure described in Usage Scenario J, infra. This allows a legitimately registered customer to resume use of all authorized software even if the original SCD 101 is never recovered.

Fifth, as an alternative or adjunct to the personal identification query/response system, the customer can designate an SCD 101 as a master identification SCD of one or more other SCDs. This master identification SCD may be presented by the customer and used in lieu of the personal identification query/response process in Scenarios H, I and J, infra, for any of the linked SCDs.

The master identification SCD is useful in business applications where the person responsible for managing and maintaining license rights may change over time. Of course, the master identification SCD is preferably kept physically secure at all times. Deactivation of a lost master identification SCD would require the use of the personal identification query/response system or of another master identification SCD linked to the master identification SCD to be deactivated.

Transfer or Sale of Customer Usage Rights

The system for DRM includes a method for a customer to transfer usage rights to another user (If allowed by the terms of the usage rights). Transfers can be permanent (sale), time-limited (loan or rent), renewable or revocable.

The mechanism is similar to that used for license pool operation. The customer in possession of the source SCD containing the usage rights to be transferred connects that SCD to a consumer electronic device 203 containing Core Protection Layer Software 301 and DRM Layer Software 307. The customer in possession of the destination SCD connects that SCD to the same consumer electronic device 203 or to another consumer electronic device having a network connection to that device.

The customer in possession of the source SCD uses the core DRM software 706 to communicate with the destination SCD and obtain the public encryption key for the destination SCD. The source customer then uses the core DRM software 706 to create a transfer token string encrypted with the public encryption key of the vendor associated with the application being transferred. Once the transfer token has been created, the source SCD can no longer be used to authorize the usage rights being transferred.

The source customer then uses the core DRM software 706 to transfer token string along with the source and destination public keys via a secure WAN connection to the vendor server 212 associated with the application. The vendor server software verifies that the source customer has the right to perform the transfer. If so, the vendor server 212 locates or creates the vendor rights database 214 entry for the destination SCD, and transfers the specified usage rights from the source SCD record to the destination SCD record.

The customer in possession of the destination SCD can now perform Scenario B, infra, to acquire the usage rights.

Usage Scenarios

The following sections describe usage scenarios, in which various capabilities of the system are achieved.

Scenario A. Customer Acquires and Registers a New Secure Computing Device

1. Customer purchases or otherwise receives a new SCD 101 containing only the core DRM software 706 and a Public/Private Encryption Key pair 705 unique to that specific device.
2. Customer connects the new SCD 101 to a consumer electronic device 203 having wide area network (WAN) access 209.
3. Customer installs the consumer electronic device resident DRM software components 301, 307 provided with the new SCD 101.
4. Customer uses the DRM server communications protocols 309 on the consumer electronic device 203 to establish a secure communications link via the WAN 210 to the DRM server 216. This may be accomplished using established protocols such as Secure Sockets Layer (SSL). This can be a high or low bandwidth network connection such as a dialup connection.
5. The software running on the DRM server 216 receives the public encryption key from the SCD 101, and sends its own public encryption key to the DRM server communications protocols 309 on the consumer electronic device 203.
6. The DRM server software queries the Digital Rights database 218 for a record containing the new SCD public encryption key.
7. If a database record is not found, the SCD 101 is not authorized. The DRM server software sends a message to the customer stating that the SCD 101 is not valid, and this scenario ends.
8. If a database record for the public key is found, the DRM server software queries the record to determine if the SCD 101 has previously been registered.
9. If the SCD 101 has been previously registered, it cannot be re-registered. The DRM server software sends a message to the customer stating that the SCD 101 is already registered, and this scenario ends.
10. If the SCD 101 has not been previously registered, the DRM server software requests the customer to select a personal identification number (PIN) or pass phrase to be entered by the customer each time the SCD is connected to a consumer electronic device 203.
11. The DRM server communications protocol 309 encrypts the PIN or pass phrase with the SCD public encryption key, and stores the encrypted PIN in the SCD 101. From this point on, the customer must enter the PIN each time the SCD 101 is connected to a consumer electronic device 203.
12. The DRM server software requests an identifier string for the SCD 101. This identifier string will be used by the customer to differentiate this SCD from others that may be currently or later registered to the customer.
13. The DRM server software next requests personal identification information from the customer to aid in the recovery of DRM information if the SCD 101 is ever lost or stolen. This information includes:
   a. Valid customer email address
   b. Customer responses to a series of predefined or customer defined security questions such as “What is your mother's middle name?” and “What is your favorite city?”
14. The customer need not honor these requests, but if the information is not provided the customer will be unable to report his SCD 101 as lost or stolen, and will be unable to recreate any digital rights information contained in the lost or stolen SCD.
15. If the customer chooses to provide the requested information, the DRM layer software 307 on the consumer electronic device 203 collects the email address and question answers from the customer.
16. The email address is encrypted using the DRM server public encryption key and is sent to the DRM server 216 via the secure network connection.
17. The customer responses to the security questions are not sent to the DRM server
16. Rather, the DRM layer software 307 on the consumer electronic device 203 uses a message digest algorithm such as MD5 to create an irreversible message digest of the set of answers.
18. The message digest is then encrypted with the DRM server public encryption key and is sent to the DRM server 216.
19. The DRM server software creates a record in the digital rights database 218 which associates the message digest with the public encryption key for the new SCD 101. This message digest will be used as a unique user identifier key in the event the SCD 101 is ever lost or stolen.
20. The DRM server software updates the database record for the SCD public encryption key, indicating that this SCD 101 has been registered.
21. This scenario ends.
   Scenario B. Customer Installs and Registers a New Protected Application
1. Customer obtains a copy of the distribution and installation package for the protected application. This package is not complete—it does not contain the CCFs for the protected application or it does contain the CCFs but they are encrypted. The package can be obtained from a number of sources, including, but not limited to:
   a. Purchased as a shrink-wrapped software package;
   b. Purchased on writable media from a software distribution kiosk;
   c. Downloaded via the network from a vendor or other eCommerce file server;
   d. Obtained as part of the viral distribution process from another customer possessing a licensed copy of the application. See Scenario E, infra.

Each distribution and installation package for a protected application is digitally watermarked with a unique data pattern identifying the registered person or company which supplied that specific package. This digital watermark is used for allocating compensation in the viral distribution process. See Scenario E, infra.
2. Using removable media 207, a network connection, or other appropriate data transfer means, the customer transfers the distribution and installation package to a consumer electronic device 203 on which the application is to be installed.
3. Customer connects a previously registered SCD 101 to the same consumer electronic device 203.
4. Customer runs the application installer program, which installs all the non-protected content of the application on the consumer electronic device 203.
5. During the installation process, the installer program queries the consumer electronic device resident DRM layer software 307 to determine if the SCD 101 is present. If not, the installer program notifies the customer that a registered SCD 101 is required to complete the installation and registration of the protected application. At this time the user can either connect a registered SCD 101 or terminate the installation and resume when a registered SCD is available. If the user does not possess a registered SCD 101, this scenario ends. The user must complete Scenario A, supra, prior to restarting this Scenario.
6. The installer program determines if the application being installed was obtained as a shrink-wrapped package. This may be done by either checking the digital watermark, or by querying the customer.
7. If this is a shrink-wrapped package, the customer is prompted to enter the activation string. The customer may do this by manually entering the string using the keyboard, or by optically scanning a printed encoding such as a barcode or OCR representation, or by electronically scanning an RF-ID element, or by transferring the data from any other means which could be packaged with the shrink-wrapped distribution and used to record the activation string.
8. The installer program instructs the consumer electronic device resident DRM layer software 307 to check if there is sufficient room on the SCD 101 to hold the CCFs for the protected application being installed. If not, the software prompts the customer to perform an archive procedure to move some of the content of the SCD 101 onto a backup storage device—such as a non-volatile memory card or a disk drive on a computer. The archived information is encrypted such that it can only be read by the SCD 101 that created it.
9. When there is sufficient room on the SCD 101, the installer program instructs the consumer electronic device resident DRM layer software 307 to create a data record 701 in the SCD for the protected application being installed. This record 701 initially contains the identifier string for the protected application, the public encryption key of the person or company that supplied the distribution package, the activation code if this was a shrink-wrapped distribution, and a network Uniform Resource Locator (URL) for the software vendor server 212 capable of performing the registration and activation of that application.
10. If the consumer electronic device 203 on which the application is being installed has access to the WAN 210, the consumer electronic device resident DRM layer software 307 establishes a secure communications link via the WAN to the vendor server 212.
11. The consumer electronic device resident DRM layer software 307 and the vendor server software exchange public encryption keys.
12. The consumer electronic device resident DRM layer software 307 also sends the identifier string for the protected application being installed and the public encryption key of the distribution package supplier.
13. The vendor server software queries the vendor rights database 214 to determine the current rights, if any, assigned to the customer's SCD Public key.
14. If the presented customer SCD public key is already registered in the vendor rights database 214 as having rights to run the specified protected application, and these rights have never been transferred to the SCD 101, the transaction is considered to be a new install of software for which the customer already has usage rights (due to purchase, rental, evaluation license, etc.). The scenario continues at step 28 of this scenario.
15. If the presented SCD public key is already registered in the vendor rights database 214 as having rights to run the specified protected application, and these rights have previously been transferred to the SCD 101, the transaction is considered to be a re-install of software for which the customer already has usage rights (due to purchase, rental, evaluation license, etc.). The server software queries the customer to determine if this is a simple re-install or an upgrade/revision. For a re-install, the scenario continues at step 28 of this scenario. For an upgrade or revision, the scenario continues at step 25 of this scenario.
16. If the presented SCD public key is already registered in the vendor rights database 214, but has never been granted any rights to run the specified protected application, the transaction is considered to be a new install, and the scenario continues at step 25 of this scenario.
17. If the presented SCD public key is not registered in the vendor rights database 214, the vendor server software establishes a secure connection via the WAN 210 with the DRM server software, and requests confirmation that the customer's SCD public key is properly registered in the digital rights database 218.
18. If the customer's SCD public key is not registered in the digital rights database 218, the vendor server software notifies the customer to register the SCD 101 or connect a properly registered SCD.
19. If the customer then connects a registered SCD 101, this scenario resumes from step 8.
20. If the customer's SCD public key is registered in the digital rights database 218, the DRM server 216 returns an authentication message to the vendor server 212. In addition, if the SCD 101 has been registered via Scenario J, infra, as the replacement for a previously deactivated SCD, the authentication message contains a reference to the public encryption key for the deactivated SCD.
21. If the current SCD 101 is a replacement SCD, the vendor queries the vendor rights database 214 to determine if the replaced SCD is registered there.
22. If there is a data record for the replaced SCD 101 in the vendor rights database 214, the vendor server software creates a data record for the replacement SCD, and transfers any and all rights from the replaced SCD record to the replacement SCD record. The data record for the replaced SCD 101 is marked as obsolete.
23. If the current SCD 101 is not a replacement SCD, or is a replacement for an SCD previously unregistered with this vendor, the vendor server software creates a new record in the vendor rights database 214 for the SCD, showing no current usage rights.
24. If an activation code was entered by the customer in step 7, and the vendor server 212 determines that the activation code is valid, this is a new install of a shrink-wrapped application package. The vendor server software locates the record for the activation code in the vendor rights database 214, and marks it as having been used. The scenario continues at step 27.
25. Vendor server software transfers customer connection to an eCommerce licensing agent 220 to allow the customer to acquire or upgrade usage rights for the protected application being installed. This licensing agent 220 may be part of the same vendor infrastructure, or part of an external system run by the same or different business. This procedure is described in Scenario C, infra.
26. If the customer completes Scenario C, infra, without acquiring rights to run the specified protected application, this scenario ends.
27. Since the customer has acquired new usage rights for the protected application software package, the vendor server software determines what if any credit should be issued to the person or company which distributed the distribution package to the current customer. The vendor server software updates the record in the vendor rights database 214 for the distributor public key to show the credit allocation.
28. The vendor server software uses the customer's SCD public key to encrypt either the CCFs (if the CCFs are stored on the server) or the CCF decryption key (if the CCFs were included in encrypted form in the application and distribution package) for the protected application being installed. Optionally, to reduce computational complexity, the vendor server software can enter into a key negotiation algorithm (such as Diffie-Hellman) with the SCD 101 to establish a secret encryption key. This encryption key can then be used by the vendor server software to encrypt the CCF('s) using a less computationally intensive but equally secure single key encryption algorithm.
29. The vendor server software also constructs a digital license certificate defining the specific software usage rights granted to the customer. The server software then encrypts this license certificate with the customer's SCD public key or with the private encryption key negotiated in step 28 of this scenario.
30. The vendor server software transfers the encrypted CCF('s) or the CCF decryption key and digital license certificate via the secure WAN 210 connection to the consumer electronic device resident DRM layer software 307.
31. The consumer electronic device resident DRM layer software 307 transfers the CCF('s) to the customer's secure computing device 203.
32. This scenario ends.
   Scenario C. Customer Acquires Usage Rights for a Protected Application
1. Customer contacts a licensing agent 220 authorized to sell or otherwise grant usage rights for the desired protected end-user application. This contact may be either at an actual place of business such as a computer software store, or through an eCommerce site on the wide area network 210.
2. If more than one license type is available for the protected application, the customer selects the desired license type. Available license types are determined by the digital rights owner that created the protected application and could include, but are not limited to: time or feature limited trial license, full license, upgrade license, time or usage limited rental license, rent-to-buy license.
3. If not already connected as part of another scenario, the customer connects an SCD 101 to a consumer electronic device 203 with communications to the licensing agent 220.
4. If acquisition of the selected license type requires payment from the customer, the payment transfer is handled by a transaction sequence outside the scope of this scenario.
5. When the licensing agent 220 has received required compensation, if any, software on the licensing agent server establishes a secure connection to the vendor server 212, via the WAN 210 or via communications links internal to the vendor infrastructure 223.
6. The licensing agent 220 uses a vendor public encryption key to encrypt a license authorization message, and sends this message to the software on the vendor server 212.
7. Upon receipt and validation of the license authorization message, the vendor server software locates the record for the customer SCD public key in the vendor rights database 214, and adds the license authorization to the database record.
8. At this point, the usage rights acquisition is complete, and the customer can begin or resume Scenario B, supra, at any time.
9. This scenario ends.
   Scenario D. Customer Purchases a Shrink-Wrapped Protected Application
1. Customer purchases or otherwise obtains a physical package containing at least a certificate containing an activation token.
2. The package may also include some digital medium containing a copy of the distribution and installation package for the desired protected application. The activation token contains a unique activation string which has been digitally signed and authenticated by the software vendor.
3. The package may also include a new SCD 101.
4. If the package contains a new SCD 101 and the customer wishes to use this SCD to register the end-user application, the customer completes Scenario A, supra.
5. If the shrink-wrapped package contains the distribution and installation package, the customer continues with step 2 of Scenario B, supra.
6. If the shrink-wrapped package does not contain the distribution package, the customer continues with step 1 of Scenario B, supra.
7. This scenario ends.
   Scenario E. Customer Acquires a Protected End-User Application via Viral Distribution or Software Kiosk.
1. Any registered customer with sufficient licensed rights for a protected end-user application (as determined by policies established by the vendor) can use the application installer program to create a copy of the distribution and installation package for that end-user application. This distribution and installation package can be transferred to another end-user.

This newly created distribution and installation package is digitally watermarked with a unique data pattern identifying that customer. This digital watermark is used for allocating compensation in the viral distribution process.
2. The customer creating and transferring the distribution and installation package may be an individual end-user, or a software distributor operating a form of kiosk.
3. A kiosk is an electronic distribution mechanism in which a computer contains or has access to distribution and installation packages for a number of protected applications, and the means to transfer one or more of these packages at a time using wired or wireless communication or network connection or removable media such as portable memory devices, writable CDs or DVDs. Typically, each of these packages would be watermarked with the identity of the kiosk operator.
4. Whether the distribution and installation package is created by a kiosk operator or by an individual end-user, the remainder of the scenario is the same.
5. When a potential customer/end-user obtains the watermarked distribution and installation package, and acquires usage rights by completing Scenario B, supra i.e. registers the copy of the end-users application, the creator of the distribution package is rewarded by being granted credit for compensation as defined by the vendor policies. This compensation could consist of commission payments, points towards free or discounted products or upgrades, rental license extensions or cost reductions, other services such as free technical support, etc. The end-user is not able to run the end-user application until he registers his copy of the end-user application. Alternatively, the end-user may be able to use the end-user application a limited number of times or use of the end-user application is otherwise restricted before registration, as previously described.
6. Although as described here, each distribution and installation package contains one and only one “creator” watermark, it is also be possible for each package to maintain multiple watermarks—perhaps saving the most recent N watermarks. In this way, multi-tiered viral distribution infrastructures can be supported.
7. This scenario ends.
   Scenario F. Runtime Software Protection
1. Customer connects an SCD 101 registered via Scenario A, supra, and containing a valid usage authorization data record for the desired protected application to a consumer electronic device 203 on which the desired protected application software has been previously installed via Scenario B, supra.
2. Consumer electronic device resident core protection layer software 301 prompts the user for the PIN/Pass phrase associated with the SCD 101.
3. Customer enters the PIN/Pass phrase. The entry is passed to the SCD 101 for validation.
4. If the correct PIN/Pass phrase is entered, the scenario continues at step 7. If not, the customer is informed that the wrong data was entered, and the error count is incremented.
5. If the PIN/Pass phrase is incorrect and the error count is less than the maximum allowable count (for example 3), the scenario restarts at step 2.
6. If the maximum number of allowable erroneous entries have been attempted, the SCD 101 disables itself, and cannot be used until being reactivated using the procedure described in Scenario I, infra. This scenario ends.
7. Once the SCD 101 is connected and the proper PIN/Pass phrase has been entered and validated, the customer starts the protected application software.
8. If the connected SCD 101 does not contain valid usage authorization for the protected application software, the consumer electronic device resident DRM layer software 307 informs the user, and this scenario ends.
9. The protected application software runs until encountering the first CCF. At this point, the proxy software 306 is invoked with the arguments required by the CCF.
10. The proxy software 306 passes the CCF identifier and arguments to the SCD 101. The SCD 101 decrypts and executes the specified CCF, and returns any results to the proxy software 306.
11. The proxy software 306 passes the returned results to the application software.
12. Steps 9 through 11 continue as the customer continues to run the protected software.
13. This scenario ends.
   Scenario G. Customer Performs Required Periodic “Phone-Home” SCD Validation
1. Customer connects an SCD 101 and enters the associated PIN/Pass phrase by following the steps 1 though 6 of Scenario F, supra.
2. Customer runs the local user interface software 305 of the consumer electronic device resident core protection layer software 301 and directs the software to perform the validation procedure.
3. The consumer electronic device resident core protection layer software 301 obtains the public encryption key from the connected SCD 101, and sends this key to the DRM server 216 for validation.
4. The DRM server 216 queries the data record for the SCD public key in the digital rights database 218. If the data record shows no problem with the specified SCD 101, this scenario continues at step 7.
5. If the data record shows the SCD 101 has been marked for deactivation (via Usage Scenario H, infra), the DRM server 216 encrypts a deactivation message using the SCD public encryption key and sends it to the consumer electronic device resident software, which in turn sends the deactivation message to the SCD.
6. Once deactivated, the SCD 101 cannot be used until reactivated using the procedure described in Scenario I, infra. This scenario ends.
7. Since there is no problem registered with the SCD 101, the DRM server 216 encrypts a validation message using the SCD public encryption key, and sends it to the consumer electronic device resident software which in turn sends the validation message to the SCD.
8. Upon receipt and authentication of the validation message, the SCD 101 resets its internal deactivation timer.
9. This scenario ends.
   Scenario H. Customer Deactivates a Lost or Stolen Secure Computing Device
1. If the customer did not provide personal identification information in steps 13 through 15 of Scenario A, supra, this deactivation sequence cannot be performed, in which case this scenario ends.
2. Otherwise, the customer uses a consumer electronic device 203 with WAN 210 access to connect to the DRM Server 216.
3. Customer directs the DRM Server software to perform the deactivation procedure
4. The DRM Server software sends a message containing a unique identifier character sequence to the email address contained in the data record for the SCD 101 in the digital rights database 218.
5. The DRM server 216 notifies the customer that the email has been sent, and instructs the customer to retrieve the message, and reply following the directions contained in the email.
6. If the customer does not properly reply to the sent email within a specified time, the deactivation sequence is canceled, and this scenario ends.
7. If the customer properly retrieves and replies to the sent email, the DRM Server software requests the consumer electronic device resident software to prompt the customer for answers to the security questions originally answered by the customer in steps 13 thru 15 of Scenario A, supra.
8. The DRM software on the consumer electronic device 203 collects the answers, and uses a message digest algorithm such as MD5 to create an irreversible digest of the set of answers. This message digest is then encrypted with the DRM server public encryption key, and sent to the DRM server 216.
9. If the message digest does not match the digest created during the original registration of the SCD 101, the deactivation sequence is canceled, and this scenario ends.
10. Otherwise, the DRM server 216 uses the message digest string as a secondary access key to the digital rights database 218, and locates the data records for all associated SCDs 101.
11. The server software presents the customer with a list containing the identifier strings assigned to each SCD 101 when initially registered.
12. The customer selects the SCD('s) 101 to be deactivated.
13. The data record for the associated SCD('s) 101 is (are) marked for deactivation.
14. The customer is notified of the successful operation.
15. This Scenario ends.
   Scenario I. Customer Reactivates an SCD Previously Deactivated Due to Lost/Stolen Report or Excessive Number of Invalid PIN/Pass Phrase Entries.
1. If the customer did not provide personal identification information in steps 13 through 15 of Scenario A, supra, this reactivation sequence cannot be performed. This Scenario ends.
2. Otherwise, the customer uses a consumer electronic device 203 with WAN 210 access to connect to the DRM server 216.
3. Customer directs the DRM server software to perform the reactivation procedure.
4. The DRM Server software sends a message containing a unique identifier character sequence to the email address contained in the data record for the SCD 101 in the digital rights databasev 218.
5. The DRM server notifies the customer that the email has been sent, and instructs the customer to retrieve the message, and reply following the directions contained in the email.
6. If the customer does not properly reply to the sent email within a specified time, the reactivation sequence is canceled, and this scenario ends.
7. If the customer properly retrieves and replies to the sent email, the DRM Server software requests the consumer electronic device resident software to prompt the customer for answers to the security questions originally answered by the customer in steps 13 thru 15 of Scenario A, supra.
8. The DRM software on the consumer electronic device 203 collects the answers, and uses a message digest algorithm such as MD5 to create an irreversible digest of the set of answers. This message digest is then encrypted with the DRM server public encryption key, and sent to the DRM server 216.
9. If the message digest does not match the digest created during the original registration of the SCD 101, the reactivation sequence is canceled, and this scenario ends.
10. Otherwise, the DRM server 216 uses the message digest string as a secondary access key to the digital rights database 218, and locates the data records for all SCDs 101 associated with that e-mail address currently marked as deactivated.
11. The DRM server 216 presents the customer with a list containing the identifier strings assigned to each located SCD 101 when initially registered.
12. The user selects the SCD('s) 101 to reactivate.
13. The data record for the associated SCD('s) is 101 (are) marked for reactivation.
14. The customer is notified of the successful operation.
15. The specified SCD 101 will be reactivated the next time the SCD is connected to a consumer electronic device 203 for use in any of the scenarios requiring communication with the DRM server 216.
16. This scenario ends
   Scenario J. Customer Replaces a Lost or Stolen SCD and Reconstructs Usage rights Previously Assigned to that Card
1. If the customer did not provide personal identification information in steps 13 through 15 of Scenario A, supra, this sequence cannot be performed. This replacement scenario ends.
2. Otherwise, the customer uses a consumer electronic device 203 with WAN 210 access to connect to the DRM server 216.
3. Customer directs the DRM server software to perform the replacement procedure.
4. The DRM server software sends a message containing a unique identifier character sequence to the email address contained in the data record for the SCD 101 in the digital rights database 218.
5. The DRM server 216 notifies the customer that the email has been sent, and instructs the customer to retrieve the message, and reply following the directions contained in the email.
6. If the customer does not properly reply to the sent email within a specified time, the replacement sequence is canceled, and this scenario ends.
7. If the customer properly retrieves and replies to the sent email, the DRM Server software requests the consumer electronic device resident software to prompt the customer for answers to the security questions originally answered by the customer in steps 13 thru 15 of Scenario A, supra.
8. The DRM software on the consumer electronic device 203 collects the answers, and uses a message digest algorithm such as MD5 to create an irreversible digest of the set of answers. This message digest is then encrypted with the DRM server public encryption key, and sent to the DRM server 216.
9. If the message digest does not match the digest created during the original registration of the SCD 101, the replacement sequence is canceled, and this scenario ends.
10. Otherwise, the DRM server 216 uses the message digest string as a secondary access key to the digital rights database 218, and locates the data records for all SCDs 101 associated with that e-mail address that have been marked as deactivated.
11. The server software presents the customer with a list containing the identifier strings assigned to each SCD 101 when initially registered.
12. The customer selects the SCD('s) 101 to be replaced.
13. For each SCD 101 to be replaced, server software prompts the customer to connect the replacement SCD to the consumer electronic device 203. Each replacement SCD 101 must have been previously registered using the procedure described in usage Scenario A, supra.
14. The user connects the replacement SCD 101 to the consumer electronic device 203, and enters the associated PIN/Pass phrase.
15. The DRM server software receives the public encryption key from the replacement SCD 101, and verifies it has been properly registered.
16. If the replacement SCD 101 has not been properly registered, the customer is notified, and this scenario ends.
17. If the replacement SCD 101 is properly registered, the DRM server 216 creates a link between the data record for the replacement SCD and the data record for the deactivated SCD.
18. The deactivated SCD 101 can no longer be reactivated.
19. From this point forward, vendor server software can query the DRM server 216 and receive confirmation that the new SCD 101 has replaced the deactivated SCD, and is eligible to be assigned all usage rights previously assigned to the deactivated SCD.
20. The customer is notified of the successful operation.
21. At this point, the customer can use the replacement SCD 101 to perform the reinstall procedure defined in Scenario B, supra, for each protected application for which the replaced SCD contained a data record 701.
22. If the customer is not certain about all usage rights assigned to the replaced SCD 101, the consumer electronic device resident DRM layer software 307 can perform a special search operation. The DRM layer software 307 first obtains from the DRM server 216 a list of all participating vendor URLs. The DRM layer software 307 then sends a query message containing the public key of the replaced key to each vendor server 212 in the list. Each vendor returns an acknowledgement message stating whether the replaced SCD 101 is registered with that vendor. The customer can then perform the reinstall procedure in Scenario B, supra, for each vendor with which the replaced SCD 101 was registered.

Although the present invention has been described in considerable detail with reference to certain preferred versions thereof, other versions are possible. For example, the reward can be divided among multiple customers. Therefore, the spirit and scope of the appended claims should not be limited to the description of the preferred versions contained herein.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means or step for” clause as specified in 35 U.S.C. § 112.

1. A method of digital rights management comprising:
allowing an end-user to execute a first portion of code on a consumer electronic device;
allowing the end-user to install a second portion of code on a secure computing device, in communication with the consumer electronic device, wherein the second portion of code is encrypted;
allowing the end-user to download a first decryption key for the second portion of code;
allowing the end-user to decrypt the second portion of code;
allowing the end-user to execute the second portion of code in the secure computing device; and
allowing the end-user to register the end-user application.

2. The method of claim 1 wherein the second portion of code is copied or transferred from the consumer electronic device to the secure computing device.

3. The method of claim 1 wherein the first portion of code contains at least one call to the second portion of code.

4. The method of claim 1 wherein the end-user application can only be fully functional when the second portion of code is executed.

5. The method of claim 1 wherein the second portion of code comprises at least one critical code fragment.

6. The method of claim 1 wherein the decryption key is downloaded from a first end-user application vendor.

7. The method of claim 6 wherein the first decryption key is downloaded to the secure computing device.

8. The method of claim 1 wherein the second portion of code is downloaded from a first end-user application vendor.

9. The method of claim 1 further comprising:
allowing an end-user to install a third portion of code on the secure computing device, wherein the third portion of code is encrypted; and
allowing an end-user to download a second decryption key for the third portion of code.

10. The method of claim 9 wherein the third portion of code is downloaded from a second end-user application vendor.

11. The method of claim 9 wherein the decryption key is downloaded from a second end-user application vendor.

12. The method of claim 11 wherein the second decryption key is downloaded to the secure computing device.

13. The method of claim 1 wherein the end-user must register the end-user application before the end-user is allowed to execute the second portion of the code.

14. A method of digital rights management comprising:
installing a first portion of code on a consumer electronic device;
installing a second portion of code on a secure computing device in communication with the consumer electronic device wherein the second portion of code is encrypted;
downloading a first decryption key for the second portion of code;
decrypting the second portion of the code; and
executing the second portion of code in the secure computing device.

15. A method of digital rights management comprising:
allowing an end-user to execute a first portion of code of a first end-user application on a consumer electronic device;
allowing the end-user to execute a second portion of code of the first end-user application on a secure computing device in communication with the consumer electronic device, wherein the end-user able to execute a portion of code of a second end-user application on the secure computing device.

16. The method of claim 15 wherein the first end-user application is licensed or purchased from a first vendor and wherein the second end-user application is licensed or purchased from a second vendor.

17. A method of digital rights management comprising:
allowing a first end-user to execute a first portion of code of the end-user application on a first consumer electronic device;
allowing a second end-user to execute the first portion of code of the end-user application on a second consumer electronic device; and
allowing the first and second end-users to execute a second portion of code of the end-user application on a secure computing device in communication with a local area network server; wherein the local area network server is in communication with both the first and second consumer electronic devices.

18. The method of claim 17 wherein a digital identification device is in communication with the first consumer electronic device.

19. A system of digital rights management comprising:
a local area network server;
a master secure computing device in communication with the local area network server, the master secure computing device having n transfer tokens;
at least one consumer electronic device in communication with the local area network server;
an end-user secure computing device in communication with one of the at least one consumer electronic device; wherein a first portion of code of the end-user application can be executed on the at least one consumer electronic device and, after one of the n transfer tokens is transferred to the end-user secure computing device, a second portion of code of the end-user application can be executed on the end-user secure computing device.

20. A system of digital rights management comprising:
a local area network server;
a secure computing device in communication with the local area network server; and
at least one consumer electronic device in communication with the local area network server; wherein a first portion of code of the end-user application can be executed on the at least on consumer electronic device and a second portion of code of the end-user application can be executed on the secure computing device.
